(19) United States
(12) Patent Application Publication
(10) Pub. No.: US 2025/0319772 A1
(43) Pub. Date: Oct. 16, 2025

(54) METHODS, SYSTEMS, AND DEVICES FOR DIRECTING A GAZE OF A USER OF A VEHICLE

(71) Applicant: Toyota Motor Engineering & Manufacturing North America, Inc., Plano, TX (US)

(72) Inventor: Coh L. Yoshizaki, Wixom, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/634,777

(22) Filed: Apr. 12, 2024

(51) Int. Cl. B60K 35/28; B60R 1/26; G06T 11/00

(52) U.S. Cl. CPC B60K 35/285; B60R 1/26; G06T 11/00; B60K 2360/164; B60K 2360/167; B60K 2360/182; B60K 2360/191; B60K 2360/21

(57) ABSTRACT

Methods, systems, and devices for directing a gaze of a driver of a vehicle. A gaze directing system may include one or more displays located on or within the vehicle. The system may further include an electronic control unit (ECU) coupled to the one or more displays. The ECU may determine or receive a plurality of conditions of the vehicle including a current shift position, a current vehicle speed, a current steering angle, and a current turn signal status. The ECU may further select a display of the one or more displays or a portion of the one or more displays that the driver should gaze at based on one or more conditions of the plurality of conditions. The ECU may further generate a gaze indicator indicating the selected display or the selected portion that the driver should gaze at.

### BACKGROUND

### 1. Field

The present disclosure relates to methods, systems, and/or devices for directing a gaze of a user (e.g., a driver and/or a passenger) of a vehicle.

### 2. Description of the Related Art

Modern vehicles are often equipped with numerous screens and cameras to aid a user (e.g., a driver and/or a passenger) of a vehicle with various vehicle maneuvers, such as parking and/or reversing. The screens may allow the driver to view live video captured by the cameras of a surrounding area of the vehicle. However, the driver may become confused or overwhelmed when the screens are each located at different positions within a cabin of the vehicle causing the driver to search around the cabin to find a specific screen that is displaying the live video. The risk of the driver becoming confused or overwhelmed is especially present when the vehicle is new to the driver.

Accordingly, it is desirable to provide methods, systems, and devices for directing a gaze of a user of a vehicle.

### SUMMARY

In general, one aspect of the subject matter described in this disclosure may be embodied in a gaze directing system for a vehicle. The gaze directing system may include one or more displays located on or within the vehicle. The gaze directing system may further include an electronic control unit (ECU) coupled to the one or more displays. The ECU may determine or receive a plurality of conditions of the vehicle including a current shift position, a current vehicle speed, a current steering angle, and a current turn signal status. The ECU may further select a display of the one or more displays or a portion of the one or more displays that the driver should gaze at based on one or more conditions of the plurality of conditions. The ECU may further generate a gaze indicator indicating the selected display or the selected portion that the driver should gaze at.

In one aspect, the subject matter may be embodied in a gaze directing system for directing a gaze of a driver of a vehicle towing a trailer. The gaze directing system may include one or more cameras. The one or more cameras may capture real-time video data of one or more fields of view of a surrounding area of the vehicle and the trailer. The gaze directing system may further include one or more displays located on or within the vehicle. The gaze directing system may further include an electronic control unit (ECU) coupled to the one or more cameras and the one or more displays. The ECU may determine or receive a plurality of conditions of the vehicle including a current shift position, a current vehicle speed, a current steering angle, and a current turn signal status. The ECU may further select a display of the one or more displays or a portion of the one or more displays that the driver should gaze at based on one or more conditions of the plurality of conditions. The ECU may further generate a gaze indicator indicating the selected display or the selected portion that the driver should gaze at. The ECU may further transmit the real-time video data to the selected display or the selected portion to display at least one field of view of the one or more fields of view on the selected display or the selected portion.

In one aspect, the subject matter may be embodied in a method for directing a gaze of a driver of a vehicle. The method may include determining or receiving, via an electronic control unit (ECU) of the vehicle, a plurality of conditions of the vehicle from one or more sensors. The plurality of conditions may include a current shift position, a current vehicle speed, a current steering angle, and a current turn signal status. The method may further include selecting, via the ECU, a display of one or more displays located on or within the vehicle that the driver should gaze at based on one or more conditions of the plurality of conditions. The method may further include generating, via the ECU, a gaze indicator icon indicating the selected display.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram of an example gaze directing system for a vehicle according to an aspect of the disclosure.

FIG. 2 is a schematic top view of an example vehicle including the example gaze directing system of FIG. 1 according to an aspect of the disclosure.

FIG. 3 is an illustration of an example left rearward field of view according to an aspect of the disclosure.

FIG. 4 is an illustration of an example right rearward field of view according to an aspect of the disclosure.

FIG. 5 is an illustration of an example cabin of the vehicle including the example gaze directing system of FIG. 1 according to an aspect of the disclosure.

FIGS. 6A, 6B, and 6C illustrate examples of a left mirror and a right mirror of the example gaze directing system of FIG. 1 according to an aspect of the disclosure.

FIGS. 7-12 illustrate examples of gaze indicators generated by the example gaze directing system of FIG. 1 according to an aspect of the disclosure.

FIG. 13 is a flow diagram of an example process for controlling the gaze directing system of FIG. 1 according to an aspect of the disclosure.

FIGS. 14A and 14B are a flow diagram of an example process for controlling the gaze directing system of FIG. 1 according to an aspect of the disclosure.

### DETAILED DESCRIPTION

Disclosed herein are methods, systems, devices, and/or vehicles for implementing a gaze directing system. The gaze directing system may include one or more displays located within a cabin of a vehicle. Particular embodiments of the subject matter described in this disclosure may be implemented to realize one or more of the following advantages. The gaze directing system may generate a gaze indicator indicating which display of the one or more displays a user (e.g., a driver and/or a passenger) of the vehicle should gaze (i.e., look) at. The gaze indicator may be an icon that is displayed by at least one display of the one or more displays. By indicating which display of the one or more displays the user should gaze at, the gaze indicator may eliminate or at least reduce an amount of time that the user spends looking around the cabin for a specific display thereby improving safety and reducing user confusion.

Moreover, the gaze directing system may further improve safety by selecting and/or determining a display of the one or more displays that the user should gaze at based on one or more conditions of the vehicle. The one or more conditions may include a current shift position, a current vehicle speed, a current steering angle, and/or a current turn signal status of the vehicle. For example, when the current vehicle speed is above a speed threshold, the gaze directing system may select a display of the one or more displays that does not require the user to look down and away from a road the vehicle is traveling along.

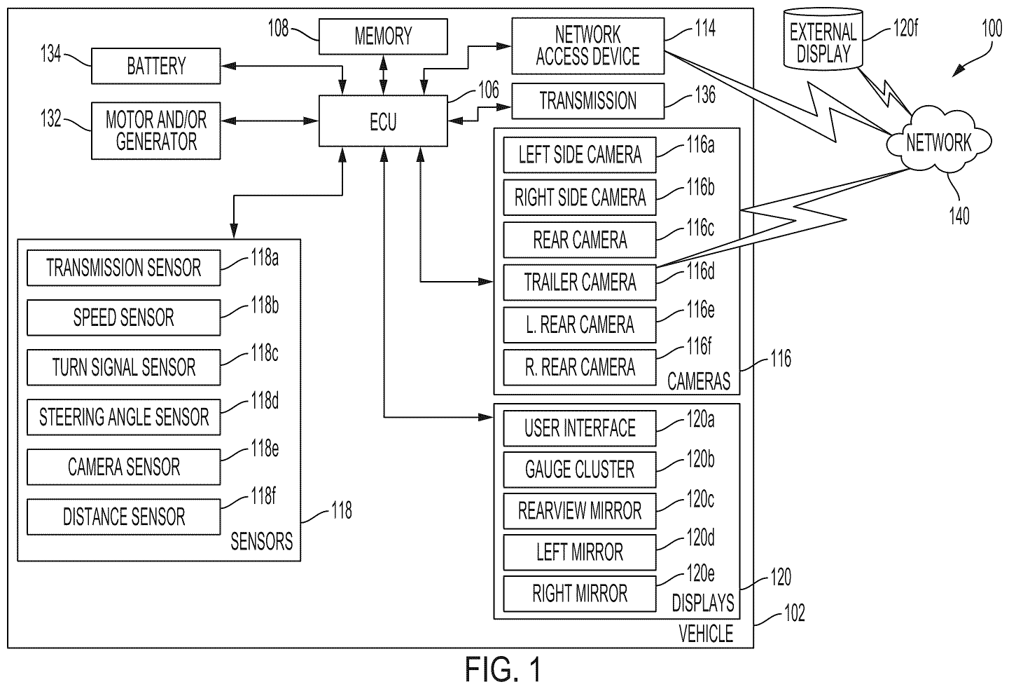

FIG. 1 is a block diagram of an example gaze directing system 100. The gaze directing system 100 or a portion thereof may be retrofitted, coupled to, include, or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The gaze directing system 100 and/or the vehicle 102 may include a motor and/or generator 132, a battery 134, and/or a transmission 136. The motor and/or generator 132 may be located within an engine bay of the vehicle 102. The motor and/or generator 132 may be an internal combustion engine (ICE). In this regard, the motor and/or generator 132 may combust an air and fuel mixture to provide power to the vehicle 102 and/or components of the vehicle 102 and/or the gaze directing system 100. Accordingly, the motor and/or generator 132 can cause the vehicle 102 to accelerate, decelerate, or maintain a desired velocity. It should be understood that the motor and/or generator 132 may include combinations of an ICE and an electric motor, such as for hybrid vehicle applications for example. In examples, the motor and/or generator 132 may be an electric motor. In this regard, the motor and/or generator 132 may be an electric motor and an electric generator that converts electrical energy into mechanical power, such as torque, and converts mechanical power into electrical energy. The motor and/or generator 132 may be electrically connected to the battery 134. The motor and/or generator 132 may convert energy from the battery 134 into mechanical power, and may provide energy back to the battery 134, for example, via regenerative braking. The battery 134 may be electrically connected to the motor and/or generator 132 and may provide electrical energy to and/or receive electrical energy from the motor and/or generator 132. The battery 134 may provide electrical energy to the gaze directing system 100.

The transmission 136 may be an automatic transmission (e.g., a 6-speed, 7-speed, 8-speed, 9-speed, or 10-speed automatic transmission) or a manual transmission (e.g., a six-speed manual transmission) having at least one reverse gear, a neutral position, and at least one forward (or drive) gear. In examples, the transmission 136 may be an electric vehicle transmission (e.g., a single speed or two speed transmission). The transmission 136 may receive torque from the motor and/or generator 132 and may transfer the torque to one or more wheels of the vehicle 102.

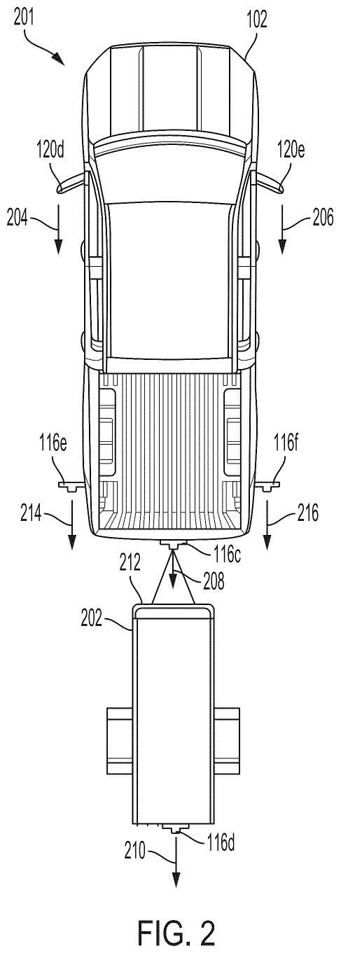

FIG. 2 illustrates an example vehicle 102 including the example gaze directing system 100 of FIG. 1. With combined reference to FIGS. 1-2, the gaze directing system 100 and/or the vehicle 102 may further include a trailer 202 removably attached to the vehicle 102 such that the vehicle 102 may tow the trailer 202. The trailer 202 may be a recreational vehicle (RV), a boat trailer, a flat bed trailer, a horse trailer, a travel trailer, a utility trailer, or any other trailer that may be towed by the vehicle 102. In one aspect, the trailer 202 may electrically connect with the vehicle 102 such that data and/or electrical energy may be transmitted between the vehicle 102 and the trailer 202.

The gaze directing system 100 may further include one or more cameras 116. The one or more cameras 116 may be coupled to an exterior 201 of the vehicle 102. The one or more cameras 116 may include a left camera 116a, a right camera 116b, a rear camera 116c, a trailer camera 116d, a left rear camera 116e, and/or a right rear camera 116f. The one or more cameras 116 may be a digital camera, an infrared thermal camera, and/or a night vision camera (e.g., utilizing active illumination and/or image intensification). In examples, the one or more cameras 116 may be and/or include a panoramic view monitor (PVM) system of the vehicle 102. The one or more cameras 116 may provide, capture, and/or record real-time video (or video data) including images and/or video of a surrounding area of the vehicle 102 and/or the trailer 202. Each camera of the one or more cameras 116 may capture one or more fields of view that may include at least a portion of the surrounding area, the vehicle 102, and/or the trailer 202. In examples, each camera of the one or more cameras 116 may allow the user to change a zoom level of each camera (e.g., via a user interface 120a) and/or the gaze directing system 100 may automatically change the zoom level of each camera based on a speed of the vehicle 102 (e.g., the zoom level decreases as the speed of the vehicle 102 increases).

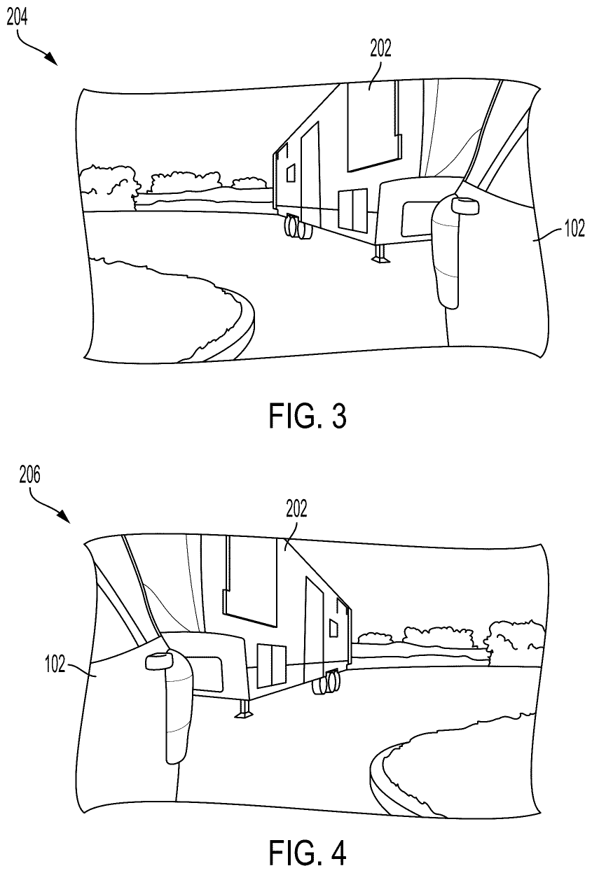

The left camera 116a may be coupled to the exterior 201, a left mirror 120d, and/or a left side of the vehicle 102 or the trailer 202 (e.g., a left side quarter panel, a left side door, etc.). In examples, the gaze directing system 100 may include a plurality of left cameras each having a different field of view and/or orientation. The left camera 116a may provide, capture, and/or record real-time video of a left rearward field of view (or direction) 204 with respect to the vehicle 102 and/or the trailer 202 (e.g., capturing a portion of the surrounding area that is to the left of the vehicle 102 and the trailer 202 and/or capturing a portion of the left side of the vehicle 102 and/or the trailer 202). Referring briefly to FIG. 3, FIG. 3 illustrates an example of the left rearward field of view 204. The left rearward field of view 204 may assist the user when making a sharp turn in the vehicle 102 by allowing the user to check for any obstacles and/or a position or angle of the trailer 202.

Returning to FIGS. 1 and 2, the right camera 116b may be coupled to the exterior 201, a right mirror 120e, and/or a right side of the vehicle 102 or the trailer 202 (e.g., a right side quarter panel, a right side door, etc.). In examples, the gaze directing system 100 may include a plurality of right cameras each having a different field of view and/or orientation. The right camera 116b may provide, capture, and/or record real-time video of a right rearward field of view (or direction) 206 with respect to the vehicle 102 or the trailer 202 (e.g., capturing a portion of the surrounding area that is to the right of the vehicle 102 and the trailer 202 and/or capturing a portion of the right side of the vehicle 102 and/or the trailer 202). Referring briefly to FIG. 4, FIG. 4 illustrates an example of the right rearward field of view 206. The right rearward field of view 206 may assist the user when making a sharp turn in the vehicle 102 by allowing the user to check for any obstacles and/or a position or angle of the trailer 202.

Returning to FIGS. 1 and 2, the rear camera 116c may be coupled to the exterior 201 and/or a rear of the vehicle 102 (e.g., a rear bumper, a rear tailgate, etc.). In examples, the gaze directing system 100 may include a plurality of rear cameras each having a different field of view and/or orientation. The rear camera 116c may provide, capture, and/or record real-time video of a first rearward field of view 208 with respect to the vehicle 102 (e.g., capturing a portion of the surrounding area that is to the rear of the vehicle 102 and/or capturing a portion of a front side 212 of the trailer 202).

The trailer camera 116d may be coupled to the trailer 202 or a rear of the trailer 202. In examples, the gaze directing system 100 may include a plurality of trailer cameras each having a different field of view and/or orientation. The trailer camera 116d may provide, capture, and/or record real-time video of a second rearward field of view (or direction) 210 with respect to the trailer 202 (e.g., capturing a portion of the surrounding area of the trailer 202 that is to the rear of the trailer 202). In examples, the trailer camera 116d may be a wireless camera such that the trailer camera 116d may wirelessing transmit the real-time video of the rearward field of view 208 to the vehicle 102.

The left rear camera 116e may be coupled to the exterior 201 and/or a left rear side of the vehicle 102 or the trailer 202 (e.g., a left rear side quarter panel, a left rear side door, etc.). In examples, the gaze directing system 100 may include a plurality of left rear cameras each having a different field of view and/or orientation. The left rear camera 116e may provide, capture, and/or record real-time video of another left rearward field of view (or direction) 214 with respect to the vehicle 102 or the trailer 202 (e.g., capturing a portion of the surrounding area that is to the left of the vehicle 102 and the trailer 202 and/or capturing a portion of the left rear side of the vehicle 102 and/or the trailer 202). In examples, the left camera 116a may capture the another left rearward field of view 214 (e.g., via a zoom function of the left camera 116a).

The right rear camera 116f may be coupled to the exterior 201 and/or a right rear side of the vehicle 102 or the trailer 202 (e.g., a right rear side quarter panel, a right rear side door, etc.). In examples, the gaze directing system 100 may include a plurality of right rear cameras each having a different field of view and/or orientation. The right rear camera 116f may provide, capture, and/or record real-time video of another right rearward field of view (or direction) 216 with respect to the vehicle 102 or the trailer 202 (e.g., capturing a portion of the surrounding area that is to the right of the vehicle 102 and the trailer 202 and/or capturing a portion of the right rear side of the vehicle 102 and/or the trailer 202). In examples, the right camera 116b may capture the another right rearward field of view 216 (e.g., via a zoom function of the right camera 116b).

The gaze directing system 100 may further include one or more sensors (or one or more vehicle sensors) 118. The one or more sensors 118 may be integrated with the vehicle 102 and/or the trailer 202. The one or more sensors 118 may measure, detect (or indicate), and/or determine one or more conditions (or one or more vehicle conditions) of the vehicle 102 periodically and/or continuously. The one or more conditions of the vehicle 102 may include a shift position, a vehicle speed, a turn signal status, a steering angle, a camera condition, and/or a proximity to one or more objects. The one or more sensors 118 may be and/or include software, hardware, firmware, or a combination thereof for measuring, detecting, and/or determining the one or more conditions of the vehicle 102. The one or more sensors 118 may include a transmission sensor (or shift sensor) 118a, a speed sensor 118b, a turn signal sensor 118c, a steering angle sensor 118d, a camera sensor 118e, and/or one or more distance sensors 118f. In examples, the gaze directing system 100 may include two or more, three or more, four or more, or all of the transmission sensor 118a, the speed sensor 118b, the turn signal sensor 118c, the steering angle sensor 118d, the camera sensor 118e, and/or the one or more distance sensors 118f.

The transmission sensor 118a may be located within the vehicle 102 and/or coupled to the transmission 136 of the vehicle 102. The transmission sensor 118a may indicate, detect, and/or determine the shift position (or gear position or mode) of the vehicle 102 and/or the transmission 136. The shift position may include drive, reverse, and/or neutral. In examples, the gaze directing system 100 may include a plurality of transmission sensors.

The speed sensor 118b may be located within the vehicle 102. The speed sensor 118b may measure, detect, and/or determine the vehicle speed of the vehicle 102. In examples, the speed sensor 118b may measure, detect, and/or determine the vehicle speed based on a rotation speed of an output shaft of the transmission 136, a rotation speed of the one or more wheels of the vehicle 102, and/or a GPS signal. In examples, the gaze directing system 100 may include a plurality of speed sensors.

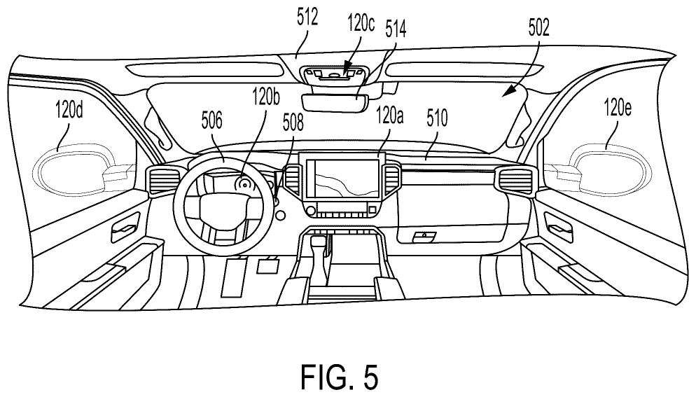

FIG. 5 is an illustration of a cabin 502 of the vehicle 102 including the gaze directing system 100 of FIG. 1. With combined reference to FIGS. 1 and 5, the turn signal sensor 118c may be located within the vehicle 102 and/or coupled to an indicator stalk 508 and/or a steering wheel 506 of the vehicle 102. The turn signal sensor 118c may indicate, detect, and/or determine the turn signal status of the vehicle 102. The turn signal status may include whether a left turn signal of the vehicle 102 is activated and/or whether a right turn signal of the vehicle 102 is activated. For example, the turn signal sensor 118c may detect when a driver of the vehicle 102 activates the left turn signal or the right turn signal of the vehicle 102. In examples, the turn signal sensor 118c may detect when the vehicle 102 activates the left turn signal or the right turn signal during, for example, autonomous driving or semiautonomous driving. In examples, the gaze directing system 100 may include a plurality of turn signal sensors.

The steering angle sensor 118d may be located within the vehicle 102 and/or coupled to the steering wheel 506 or of the vehicle 102. The steering angle sensor 118d may measure, detect, and/or determine the steering angle of the vehicle 102 (e.g., a degree of rotation of the steering wheel 506 in a left or right direction from a center (or reference) position). In examples, the gaze directing system 100 may include a plurality of steering angle sensors. The steering angle sensor 118d may indicate whether the vehicle 102 is making a turn (e.g., when the vehicle 102 turns 20 degrees or more left or right) or a minor change in direction (e.g., when the vehicle 102 turns between 0 and 20 degrees left or right).

The camera sensor 118e may be located within the vehicle 102. The camera sensor 118e may indicate, detect, and/or determine the camera condition of the vehicle 102. For example, the camera condition may include whether the trailer camera 116d is activated and/or whether the user manually selected (e.g., via a user interface 120) the left rearward field of view 204, the right rearward field of view 206, the first rearward field of view 208, and/or the second rearward field of view 208 for display.

The one or more distance sensors 118f may be coupled to the exterior 201 of the vehicle 102 and/or to the trailer 202. The one or more distance sensors 118f may be and/or include a camera, a sonar sensor, a radar sensor, and/or a lidar sensor. The one or more distance sensors 118f may measure, detect, and/or determine the proximity of one or more objects in the surrounding area of the vehicle 102 and/or the trailer 202. The one or more distance sensors 118f may measure, detect, and/or determine the proximity of the one or more objects by collecting spatial information of the one or more objects and constructing a point cloud. In examples, the gaze directing system 100 may include a plurality of distance sensors.

With combined reference to FIGS. 1-5, the gaze directing system 100 may further include one or more displays (or one or more displays and/or mirrors) 120. The one or more displays 120 may include the user interface (or infotainment display) 120a, a gauge cluster 120b, a rearview mirror 120c, the left mirror 120d, and/or the right mirror 120e. The one or more displays 120 may be native to the vehicle 102 and/or may be retrofitted to the vehicle 102. The one or more displays 120 may include a liquid crystal display (LCD), a light-emitting diode (LED) display, a segment display, a holographic display, an e-paper display, a laser color video display, and/or other display types. In examples, the one or more displays 120 may include an external display 120f (e.g., a mobile phone, a laptop, a tablet, etc.) that may have some or all of the functions (e.g., receiving and displaying images) as the user interface 120a, the gauge cluster 120b, the rearview mirror 120c, the left mirror 120d, and/or the right mirror 120e. At least one display of the one or more displays 120 may display a gaze indicator that indicates which display of the one or more displays 120 or which portion of the one or more displays 120 the user should gaze at (which is discussed in greater detail below).

The user interface 120a may be located within the cabin 502 of the vehicle 102 and/or may be coupled to a dashboard 510 of the vehicle 102 (as shown by FIG. 5). The user interface 120a may provide an interface to the user of the vehicle 102 to interact with and/or receive output from an electronic control unit (ECU) 106. The user interface 120a may have a user interface element, such as one or more screens and/or one or more touchscreens with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106. The user interface 120a may display the gaze indicator, the left rearward field of view 204, the right rearward field of view 206, the first rearward field of view 208, the second rearward field of view 210, the another left rearward field of view 214, and/or the another right rearward field of view 216.

The gauge cluster 120b may be located within the cabin 502 of the vehicle 102 and/or may be coupled to the dashboard 510 of the vehicle 102 (as shown by FIG. 5). The gauge cluster 120b may have one or more screens and/or physical indicators to display vehicle information such as a speedometer, a tachometer, an energy and/or fuel level indicator, a map, etc. In examples, the gauge cluster 120b may display the gaze indicator, the left rearward field of view 204, the right rearward field of view 206, the first rearward field of view 208, the second rearward field of view 210, the another left rearward field of view 214, and/or the another right rearward field of view 216.

The rearview mirror 120c may be located within the cabin 502 of the vehicle 102 and/or may be coupled to a ceiling 512 of the vehicle 102 (as shown by FIG. 5). The rearview mirror 120c may be an electronic rearview mirror such that a surface 514 of the rearview mirror 120c may be or include one or more screens that may display the gaze indicator, the left rearward field of view 204, the right rearward field of view 206, the first rearward field of view 208, and/or the second rearward field of view 210. In examples, the rearview mirror 120c may be a traditional (or nonelectronic) rearview mirror such that the surface 514 of the rearview mirror 120c may be or include a reflective surface that allows the user to see a reflection of at least a portion of the first rearward field of view. In examples, the rearview mirror 120c may have an electronic mode (e.g., utilizing the one or more screens of the surface 514) and a traditional mode (e.g., utilizing the reflective surface of the surface 514).

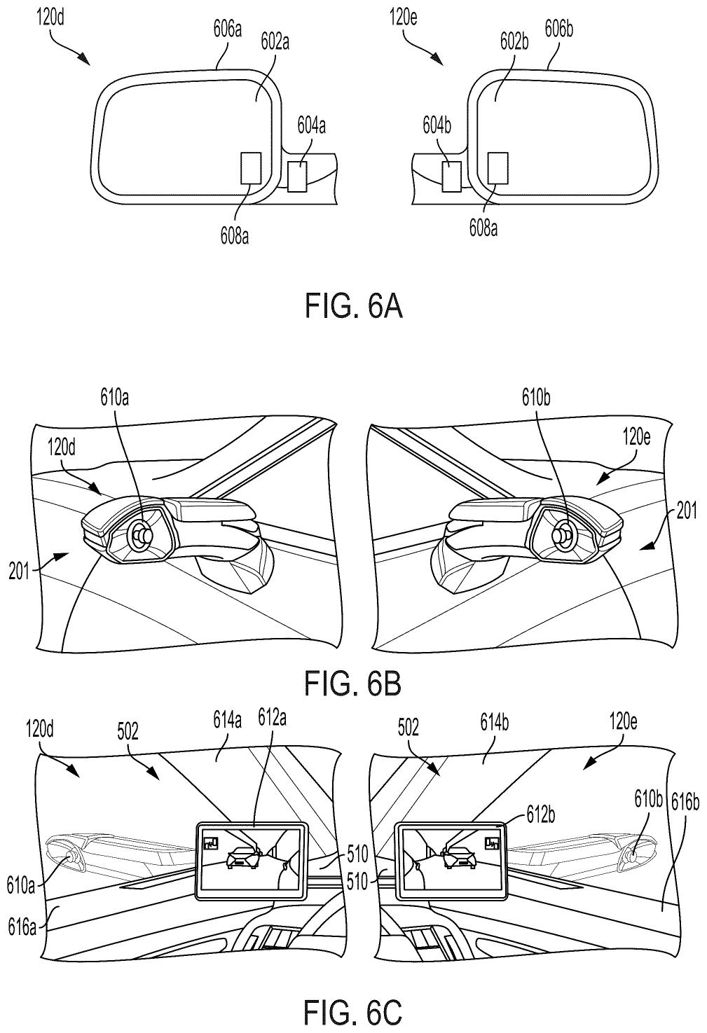

The left mirror (or left side view mirror) 120d may be located within the cabin 502 of the vehicle 102 or may be coupled to the exterior 201 of the vehicle 102 (as shown by FIG. 2). The left mirror 120d may be an electronic (or digital) left side view mirror having one or more screens that may display the gaze indicator, the left rearward field of view 204, and/or the another left rearward field of view 214. Referring briefly to FIGS. 2 and 6A, in examples, the left mirror 120d may be a traditional (or nonelectronic) left side view mirror that functions as a traditional mirror by having a reflective surface 602a that allows the user to see at least a portion of the left rearward field of view 204. In examples where the left mirror 120d is a traditional left side view mirror, the left mirror 120d may include a left gaze indicator display to display the gaze indicator. The left gaze indicator display may be a screen 604a that is integrated into a housing 606a of the left mirror 120d or may be an etched portion 608a on the reflective surface 602a of the left mirror 120d that is backlit such that light may shine through the etched portion 608a to display and/or illuminate portions of the gaze indicator. In examples, the left mirror 120d may have an electronic mode (e.g., using one or more screens to display the left rearward field of view 204) and a traditional mode (i.e., using the reflective surface 602a to show a reflection of at least a portion of the left rearward field of view 204).

Referring briefly to FIGS. 2, 6B, and 6C, in examples, the left mirror 120d may be an electronic left side view mirror that may include a left mirror camera 610a and a left mirror display 612a. The left mirror camera 610a may be and/or include the left camera 116a. In examples, the left mirror camera 610a may be coupled to the exterior 201 of the vehicle 102 and may capture at least a portion of the left rearward field of view 204. The left mirror display 612a may be located within the cabin 502 and/or may be coupled to a left A pillar 614a of the vehicle 102, a left front door 616a of the vehicle 102, and/or the dashboard 510. In examples, the left mirror display 612a may display the gaze indicator and/or at least a portion of the left rearward field of view 204 received from the left mirror camera 610a (e.g., via the ECU 106).

Returning to FIGS. 1-5, the right mirror (or right side view mirror) 120e may be located within the cabin 502 of the vehicle 102 and/or may be coupled to the exterior 201 of the vehicle 102 (as shown by FIG. 2). The right mirror 120e may be an electronic (or digital) right side view mirror having one or more screens that may display the gaze indicator, the right rearward field of view 206, and/or the another right rearward field of view 216. Referring briefly to FIGS. 2 and 6A, in examples, the right mirror 120e may be a traditional (or nonelectronic) right side view mirror that functions as a traditional mirror by having a reflective surface 602b that allows the user to see at least a portion of the right rearward field of view 206. In examples where the right mirror 120e is a traditional right side view mirror, the right mirror 120e may include a right gaze indicator display to display the gaze indicator. The right gaze indicator display may be a screen 604b that is integrated into a housing 606b of the right mirror 120e or may be an etched portion 608b on the reflective surface 602b of the right mirror 120e that is backlit such that light may shine through the etched portion 608b to display and/or illuminate portions of the gaze indicator. In examples, the right mirror 120e may have an electronic mode (e.g., using one or more screens to display the right rearward field of view 206) and a traditional mode (i.e., using the reflective surface 602b to show a reflection of at least a portion of the right rearward field of view 206).

Referring briefly to FIGS. 2, 6B, and 6C, in examples, the right mirror 120e may be an electronic right side view mirror that may include a right mirror camera 610b and a right mirror display 612b. The right mirror camera 610b may be and/or include the right camera 116b. In examples, the right mirror camera 610b may be coupled to the exterior 201 of the vehicle 102 and may capture at least a portion of the right rearward field of view 206. The right mirror display 612b may be located within the cabin 502 and/or may be coupled to a right A pillar 614b of the vehicle 102, a right front door 616b of the vehicle 102, and/or the dashboard 510. In examples, the right mirror display 612b may display the gaze indicator and/or at least a portion of the right rearward field of view 206 received from the right mirror camera 610b (e.g., via the ECU 106).

Returning briefly to FIG. 1, the gaze directing system 100 may further include one or more processors, such as the electronic control unit (ECU) 106. The ECU 106 may be implemented as a single ECU or in multiple ECUs. The ECU 106 may be electrically connected to some or all of the components of the vehicle 102 and/or the gaze directing system 100 (e.g., via a controller area network (CAN) bus and/or other protocols). The ECU 106 may be electrically connected to the one or more cameras 116, the one or more sensors 118, the one or more displays 120, a memory 108, and/or a network access device 114. The ECU 106 may include one or more processors (or controllers) specifically designed for controlling operations of the vehicle 102, such as accelerating, braking, controlling a panoramic view monitor (PVM) of the vehicle 102 (e.g., the one or more cameras 116), etc. In examples, the ECU 106 may be and/or include an advanced driver assistance systems (ADAS) sensor fusion ECU, a panoramic view monitor (PVM) ECU, an engine control module (ECM), a transmission control module (TCM), a telematics control unit (TCU), an in-vehicle infotainment (IVI) ECU, and/or a graphics processing unit (GPU).

With combined reference to FIGS. 1-5, the ECU 106 may receive or determine, via the one or more sensors 118, the one or more conditions of the vehicle 102 including the shift position, the vehicle speed, the turn signal status, the steering angle, the camera condition, and/or the proximity to one or more objects. The ECU 106 may control and/or activate the one or more cameras 116 to capture real-time video data including the left rearward field of view 204, the right rearward field of view 206, the first rearward field of view 208, the second rearward field of view 210, the another left rearward field of view 214, and/or the another right rearward field of view 216 based on the received or the determined one or more conditions of the vehicle 102.

The ECU 106 may receive the real-time video data from the one or more cameras 116 including the left rearward field of view 204, the right rearward field of view 206, the first rearward field of view 208, the second rearward field of view 210, the another left rearward field of view 214, and/or the another right rearward field of view 216. The ECU 106 may transmit the received real-time video data to the one or more displays 120 such that at least one display of the one or more displays 120 may display one or more of the left rearward field of view 204, the right rearward field of view 206, the first rearward field of view 208, the second rearward field of view 210, the another left rearward field of view 214, and/or the another right rearward field of view 216.

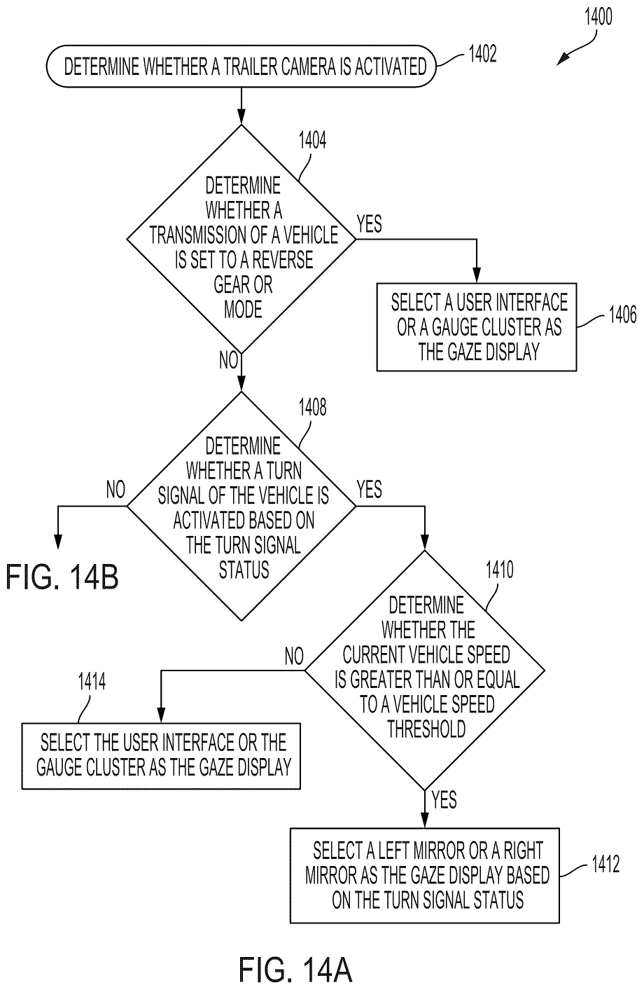

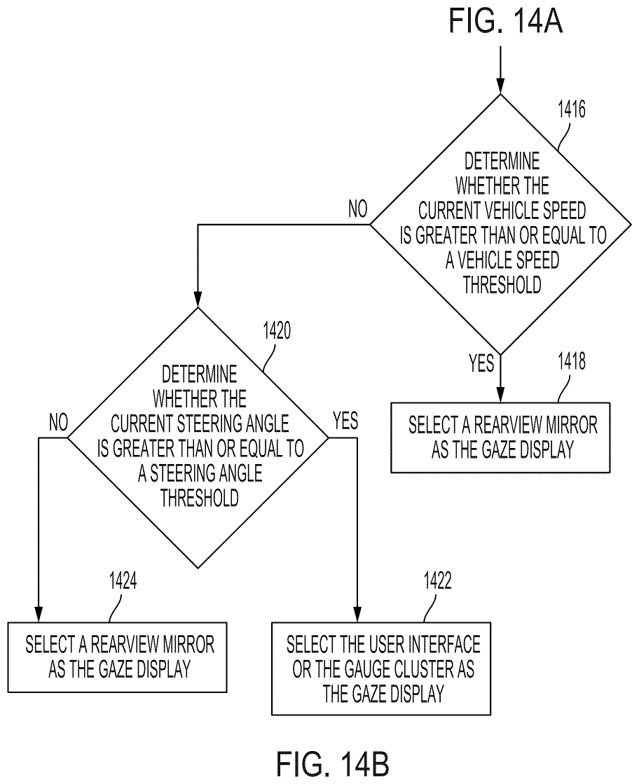

The ECU 106 may determine and/or select a display from the one or more displays 120 or a portion of the one or more displays 120 for the driver to gaze at based on the received or the determined one or more conditions of the vehicle 102 (which is discussed in greater detail below with reference to FIGS. 14A and 14B). In examples, the ECU 106 may determine and/or select a gaze display based on the received or the determined one or more conditions of the vehicle 102, the gaze display being the display of the one or more displays 120 or the portion of the one or more displays 120 for the driver to gaze at. In examples, the ECU 106 may determine and/or select the gaze display further based on one or more vehicle speed thresholds and/or one or more steering angle thresholds. In addition to the one or more conditions, the one or more vehicle speed thresholds, and/or the one or more steering angle thresholds, a particular display of the one or more displays 120 may be selected and/or determined as the gaze display based on what is being displayed on the particular display and/or a position of the particular display within the cabin 502 (e.g., the position of the particular display may not require the user to look down and away from a road the vehicle is traveling along).

In examples, the ECU 106 may determine and/or select the gaze display based on the proximity to one or more objects received from the one or more distance sensors 118f. In examples, spatial information data captured by the one or more distance sensors 118f may include one or more measurements of a distance between the vehicle 102 and the one or more objects. For example, the ECU 106 may determine whether the one or more objects are close to (e.g., within 5 feet or less) and/or going to contact the vehicle 102 based on the one or more measurements of the distance between the one or more objects and the vehicle 102. When the ECU 106 determines that the one or more objects are close to and/or going to contact the vehicle 102, the ECU 106 may select the gaze display based on where the one or more objects is located with respect to the vehicle 102 and/or the trailer 202. For example, if the one or more objects are on a left side or a right side of the vehicle 102 and/or the trailer 202, the ECU 106 may select the left mirror 120d or the right mirror 120e, respectively, as the gaze display. In examples, instead of the left mirror 120d or the right mirror 120e, the ECU 106 may select the user interface 120a as the gaze display and may display the left rearward field of view 204 or the right rearward field of view 206 to allow the user to see the one or more objects. If the one or more objects are behind the vehicle 102 and/or the trailer 202, the ECU 106 may select the user interface 120a as the gaze display and may display the first rearward field of view 208 or the second rearward field of view 210 to allow the user to see the one or more objects.

The ECU 106 may generate one or more gaze indicators to be displayed by at least one display of the one or more displays 120. The one or more gaze indicators may each indicate which display of the one or more displays 120 the user should gaze at (i.e., the gaze display). In examples, the one or more gaze indicators may be and/or include a computer graphics icon (e.g., a human machine interface (HMI) icon) that is static (i.e., not moving) or animated (i.e., portions of the computer graphics icon move and/or flash). In examples, the one or more gaze indicators may be computer controlled or generated or lite up arrows, borders that are highlighted or lite up around the one or more displays 120, indicators pointing to the display, or other attention drawing indicator(s). In examples, the ECU 106 may generate the one or more gaze indicators by processing gaze indicator data that is stored in the memory 108. The ECU 106 may transmit the gaze indicator data (or the processed gaze indicator data) to the one or more displays 120 such that the one or more gaze indicators are displayed by the one or more displays 120. In examples, the ECU 106 may generate a plurality of gaze indicators with each gaze indicator of the plurality of gaze indicators being transmitted to and displayed by one display of the one or more displays 120. Each gaze indicator may be different from one another based on which display of the one or more displays 120 each gaze indicator is transmitted to and/or which display of the one or more displays 120 is the gaze display.

In examples, the ECU 106 may dim displays of the one or more displays 120 that are not the gaze display to reduce a risk of distracting the user. The dimmed displays may display the one or more gaze indicators at a regular or increased brightness with respect to other portions of the dimmed displays such that the user may still see the one or more gaze indicators clearly.

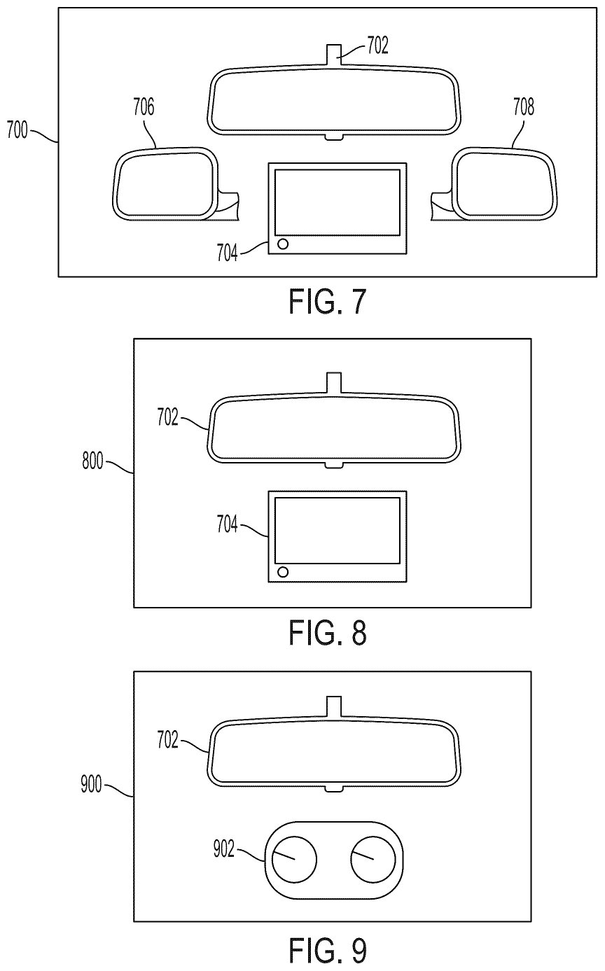

FIGS. 7-9 illustrate examples of the one or more gaze indicators as graphical icons to be displayed by the one or more displays 120, including a first gaze indicator 700, a second gaze indicator 800, and a third gaze indicator 900. With combined reference to FIGS. 1 and 7-9, the one or more gaze indicators may be and/or include one or more graphical representations of each display of the one or more displays 120. The one or more graphical representations may include a rearview mirror graphic 702 corresponding to the rearview mirror 120c, a user interface graphic 704 corresponding to the user interface 120a, a left mirror graphic 706 corresponding to the left mirror 120d, and/or a right mirror graphic 708 corresponding to the right mirror 120e (as shown by the first gaze indicator 700 in FIG. 7). In examples, the one or more graphical representations may include the rearview mirror graphic 702 and the user interface graphic 704 (as shown by the second gaze indicator 800 in FIG. 8). In examples, the one or more graphical representations may include the rearview mirror graphic 702 and a gauge cluster graphic 902 corresponding to the gauge cluster 120b (as shown by the third gaze indicator 900 in FIG. 9). It is to be understood that although not every combination is shown, the one or more gaze indicators may include any combination of the rearview mirror graphic 702, the user interface graphic 704, the left mirror graphic 706, the right mirror graphic 708, and/or the gauge cluster graphic 902. Which graphical representation(s) of the one or more graphical representations 702, 704, 706, 708, and 902 is included in the one or more gaze indicators may be based on which displays of the one or more displays 120 the vehicle 102 is equipped with. In examples, the one or more gaze indicators may not include graphical representations of every display of the one or more displays 120 to reduce an amount of information displayed and to make the one or more gaze indicators easier to understand for the user.

In examples, the one or more gaze indicators may indicate the gaze display by flashing and/or changing a color, brightness, and/or size of a graphical representation of the gaze display. For example, when the ECU 106 determines or selects the rearview mirror 120c as the gaze display, the rearview mirror graphic 702 in the one or more gaze indicators may flash and/or change colors, brightness, and/or size with respect to the other one or more graphical representations 704, 706, 708, and/or 902 included in the one or more gaze indicators.

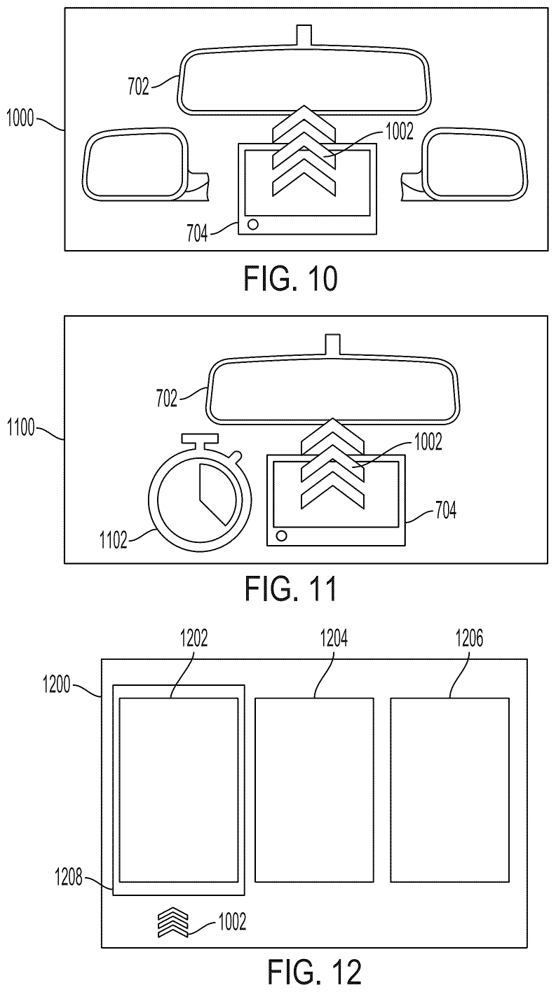

FIG. 10 illustrates an additional example gaze indicator 1000 of the one or more gaze indicators indicating the gaze display. The one or more gaze indicators may indicate the gaze display by including an arrow 1002 pointing to a graphical representation of the gaze display. For example, when the ECU 106 determines or selects the rearview mirror 120c as the gaze display, the one or more gaze indicators may include the arrow 1002 pointing to the rearview mirror graphic 702. In examples, the orientation and/or positioning of the arrow 1002 may be based on which display of the one or more displays 120 a respective gaze indicator is being displayed on. For example, if the gaze display is the rearview mirror 120c, and the gaze indicator is being displayed on the user interface 120a, the arrow 1002 may point from the user interface graphic 704 to the rearview mirror graphic 702 indicating to a user that if they are gazing at the user interface 120a they should move their gaze to the rearview mirror 120c. In examples, the arrow 1002 may be animated such that the arrow 1002 blinks and/or changes colors, brightness, and/or size, and/or portions of the arrow 1002 blink sequentially to more clearly indicate to the user which display of the one or more displays 120 is the gaze display.

FIG. 11 illustrates another example gaze indicator 1100 of the one or more gaze indicators indicating the gaze display and having a timer 1102. The one or more gaze indicators may include the timer 1102 to indicate to the user how much time remains before: the gaze display will change, the rearview mirror graphic 702 (or other graphical representation) becomes the gaze display, and/or a display displaying the timer 1102 deactivates or displays different information. A length of time that the one or more gaze indicators are displayed on the one or more displays 120 may be predetermined and/or may be set by the user (e.g., via the user interface 120a). In examples, the one or more gaze indicators may always (e.g., when the vehicle 102 and/or the one or more displays 120 are on) be displayed by the one or more displays 120 but may highlight and/or display the timer 1102 and/or the arrow 1002 for a predetermined or user set amount of time.

FIG. 12 illustrates another example gaze indicator of the one or more gaze indicators indicating a portion of the one or more displays 120 as the gaze display. In examples, the one or more gaze indicators may indicate, for example, a first portion 1202 of a main display 1200 (e.g., the user interface 120a) out of a plurality of portions as the gaze display by including a border 1208 around the first portion 1202 and/or the arrow 1002 pointing toward the first portion 1202. The border 1208 may be flashing and/or a bright color (e.g., green, blue, etc.) to more clearly indicate to the user that the first portion 1202 is the gaze display. The plurality of portions may include the first portion 1202, a second portion 1204, and/or a third portion 1206. In examples the plurality of portions may include two portions or may include four or more portions. The plurality of portions may each display the left rearward field of view 204, the right rearward field of view 206, the first rearward field of view 208, and/or the second rearward field of view 210. In examples, the plurality of portions may simultaneously display the left rearward field of view 204, the right rearward field of view 206, the first rearward field of view 208, and/or the second rearward field of view 210 with each portion of the plurality of portions displaying a different field of view. In examples, one or more portions of the plurality of portions that are not the gaze display may dim compared to the gaze display to better indicate the gaze display.

The gaze directing system 100 may further include the network access device 114. The network access device 114 may be electrically connected to the ECU 106 and may include a communication port or channel, such as one or more of a Wi-Fi unit, a Bluetooth® unit, a Radio Frequency Identification (RFID) tag or reader, a DSRC unit, and/or a cellular network unit for accessing a network 140 (e.g., CDMA, GSM, 3G, 4G, 5G, etc.). The network access device 114 may transmit data to and receive data from devices and systems not directly connected to the vehicle 102. For example, the ECU 106 may communicate with the external display 120f (e.g., a mobile device, phone, tablet, laptop, etc.), the one or more cameras 116, the one or more sensors 118, the one or more displays 120, and/or the memory 108 via the network access device 114. In examples, the trailer camera 116d may wirelessly communicate with the ECU 106 through the network access device 114. This may reduce or eliminate a need for wires running from the trailer camera 116d to the vehicle 102.

The gaze directing system 100 may further include the memory 108. The memory 108 may be electrically connected to the ECU 106. In examples, the memory 108 may be communicatively coupled (e.g., via the network 140) to the ECU 106 such that the memory 108 is remote from the ECU 106 and/or the vehicle 102. In other examples, the memory 108 may be electrically connected to the ECU 106 and a remote memory (e.g., a remote database) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., vehicle weight, vehicle length, vehicle width, vehicle height, transmission gear information, etc.). The memory 108 may further store one or more condition thresholds including the one or more vehicle speed thresholds and/or the one or more steering angle thresholds. The one or more condition thresholds may be predetermined and set by a manufacturer of the vehicle 102 and/or may be set by the user of the vehicle 102 (e.g., via the user interface 120a).

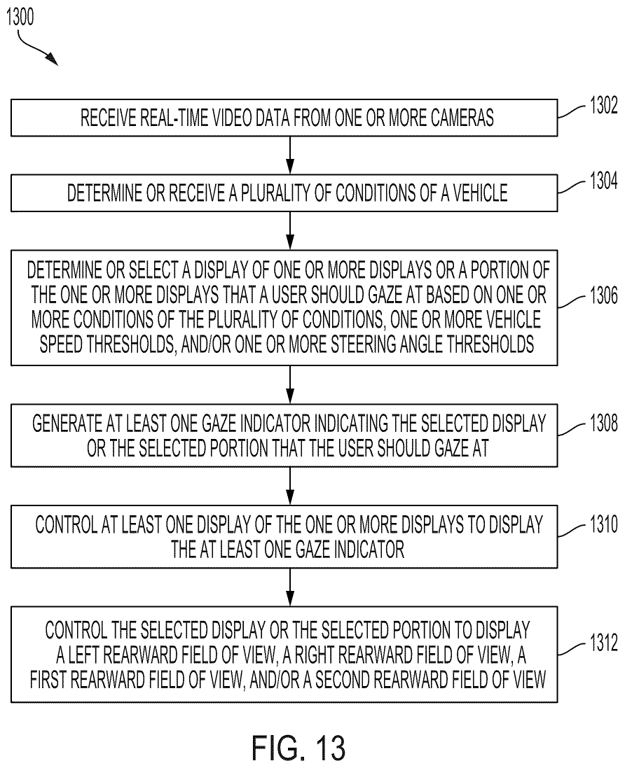

FIG. 13 is a flow diagram of an example process 1300 for controlling the gaze directing system 100. One or more computers or one or more data processing apparatuses, for example, the ECU 106 of the gaze directing system 100 of FIG. 1, appropriately programmed, may implement the process 1300. For ease of description, the process 1300 is described below with reference to FIGS. 1-12. The process 1300 of the present disclosure, however, is not limited to use of the exemplary gaze directing systems of FIGS. 1-12.

The gaze directing system 100 may receive real-time video data from the one or more cameras 116 (1302). The real-time video data may include the left rearward field of view 204, the right rearward field of view 206, the first rearward field of view 208, and/or the second rearward field of view 210.

The gaze directing system 100 may determine or receive a plurality of conditions of the vehicle 102 (1304). The plurality of conditions may include a current shift position, a current vehicle speed, a current turn signal status, a current steering angle, a current camera status, and/or a current distance to one or more objects. In examples, the ECU 106 may determine or receive the plurality of conditions of the vehicle 102 via the one or more sensors 118.

The gaze directing system 100 may determine or select a display of the one or more displays 120 or a portion of the one or more displays 120 that the user should gaze at based on one or more conditions of the plurality of conditions, a vehicle speed threshold, and/or a steering angle threshold (1306). In examples, the gaze directing system 100 may determine or select a gaze display that the user should gaze at based on the one or more conditions of the plurality of conditions, the vehicle speed threshold, and/or the steering angle threshold, the gaze display being a display of the one or more displays 120 or a portion of the one or more displays 120. FIGS. 14A and 14B further describe the process of determining or selecting the display of the one or more displays 120 or the portion of the one or more displays 120 that the user should gaze at (i.e., the gaze display).

The gaze directing system 100 may generate at least one gaze indicator indicating the selected display or the selected portion that the driver should gaze at (1308). In examples, the gaze directing system 100 may generate at least one gaze indicator indicating the gaze display. The gaze indicator may be a graphical icon including a graphical representation of at least one display of the one or more displays. In examples, the gaze indicator may indicate the selected display or the selected portion by flashing and/or highlighting a graphical representation of the selected display and/or by including an arrow pointing toward the graphical representation of the selected display. In examples where the gaze directing system 100 includes traditional left and right mirrors (i.e., the left and right mirrors 120d and 120e include reflective surfaces that do not digitally display the left rearward field of view 204 and/or the right rearward field of view 206), the at least one gaze indicator may include an etched representation of the at least one display of the one or more displays. The etched representation may be etched into the reflective surfaces of the traditional left and right mirrors such that to indicate the selected display, the ECU 106 may illuminate lights (e.g., one or more LEDs) behind the etched reflective surfaces to illuminate the etched representation of the at least one display.

The gaze directing system 100 may control at least one display of the one or more displays 120 to display the at least one gaze indicator (1310). To control the at least one display, the ECU 106 may transmit the at least one gaze indicator to the at least one display.

The gaze directing system 100 may control the selected display or the selected portion (i.e., the gaze display) to display the left rearward field of view 204, the right rearward field of view 206, the first rearward field of view 208, and/or the second rearward field of view 210 (1312). To control the selected display or the selected portion, the ECU 106 may transmit the real-time video data to the selected display or a display of the one or more displays 120 including the selected portion.

FIGS. 14A and 14B are a flow diagram of an example process 1400 for determining or selecting the gaze display (i.e., the display of the one or more displays 120 that the user should gaze at) based on the one or more conditions of the plurality of conditions, the vehicle speed threshold, and/or the steering angle threshold. One or more computers or one or more data processing apparatuses, for example, the ECU 106 of the gaze directing system 100 of FIG. 1, appropriately programmed, may implement the process 1400. For ease of description, the process 1400 is described below with reference to FIGS. 1-13. The process 1400 of the present disclosure, however, is not limited to use of the exemplary gaze directing systems of FIGS. 1-13.

The gaze directing system 100 may determine (e.g., via the ECU 106) whether the trailer camera 116d is activated (1402). The ECU 106 may determine whether the trailer camera 116d is activated based on the current camera status received from the camera sensor 118e. In examples, the ECU 106 may determine whether the trailer camera 116d is activated based on a connection status between the network access device 114 and the trailer camera 116d. In examples, if the ECU 106 determines that the trailer camera 116d is not activated, the gaze directing system 100 may deactivate.

When the ECU 106 determines that the trailer camera 116d is activated in block 1402, the ECU 106 may determine whether the transmission 136 of the vehicle 102 is set to a reverse gear or mode (1404). The ECU 106 may determine whether the transmission 136 is set to the reverse gear or mode based on the current shift position. In examples, the ECU 106 may receive the current shift position from the transmission sensor 118a. In examples, the process 1400 may begin with the ECU 106 determining whether the transmission 136 is set to the reverse gear or mode.

When the transmission 136 is set to the reverse gear or mode in block 1404, the ECU 106 may select the user interface 120a or the gauge cluster 120b as the gaze display (1406). The ECU 106 may select the user interface 120a or the gauge cluster 120b as the gaze display when the transmission 136 is set to the reverse gear or mode because the user interface 120a and/or the gauge cluster 120b are generally larger than other displays of the one or more displays 120 and therefore are optimal for providing the user a large and clear view of the surrounding area behind the vehicle 102 such as the first rearward field of view 208 and/or the second rearward field of view 210.

When the transmission 136 is not set to the reverse gear or mode in block 1404 (e.g., the transmission 136 is set to drive or neutral), the ECU 106 may determine whether a turn signal of the vehicle 102 is activated based on the turn signal status (1408). In examples, the ECU 106 may receive the turn signal status from the turn signal sensor 118c.

When the turn signal of the vehicle 102 is activated in block 1408, the ECU 106 may determine whether the current vehicle speed is greater than or equal to a vehicle speed threshold (1410). The vehicle speed threshold may be, for example, 25 mph, 35, mph, 50 mph, or any vehicle speed greater than, for example, 15 mph.

When the current vehicle speed is greater than or equal to the vehicle speed threshold in block 1410, the ECU 106 may select the left mirror 120d or the right mirror 120e as the gaze display based on the turn signal status (1412). The ECU 106 may select the left mirror 120d when the turn signal status indicates the left turn signal of the vehicle 102 is activated. The ECU 106 may select the right mirror 120e when the turn signal status indicates the right turn signal of the vehicle 102 is activated. In examples, the ECU 106 may select the left mirror 120d or the right mirror 120e as the gaze display regardless of whether the left mirror 120d and/or the right mirror 12 are traditional mirrors or electronic mirrors having a screen. The ECU 106 may select the left mirror 120d or the right mirror 120e as the gaze display when the transmission 136 is not in the reverse gear or mode, the turn signal of the vehicle is activated, and the current vehicle speed is greater than or equal to the vehicle speed threshold because the user is likely making a lane change at high speeds (e.g., on a freeway or multilane road). Therefore, it may be advantageous and safer to direct the gaze of the user to the left mirror 120d or the right mirror 120e because the user does not have to look down and away from the road and the direction may feel more natural to the user, even when the left mirror 120d or the right mirror 120e only provide reflections of the left rearward field of view 204 or the right rearward field of view 206 instead of real-time video that could be displayed by larger screens (e.g., the user interface 120a).

When the current vehicle speed is less than the vehicle speed threshold in block 1410, the ECU 106 may select the user interface 120a or the gauge cluster 120b as the gaze display (1414). The ECU 106 may select the user interface 120a or the gauge cluster 120b as the gaze display when the transmission 136 is not in the reverse gear or mode, the turn signal of the vehicle is activated, and the current vehicle speed is less than the vehicle speed threshold because the user is likely making a turn at low speeds (e.g., turning into a parking lot or navigating a parking lot or tight area). Therefore, it may be advantageous and/or safer to direct the gaze of the user to the user interface 120a or the gauge cluster 120b because the user interface 120a and/or the gauge cluster 120b may display real-time video of the left rearward field of view 204 and/or the right rearward field of view 206 which may provide a greater field of view, a zoomed in field of view, and/or a more clear field of view of a side of the vehicle 102 and/or the trailer 202 than: (i) reflections provided by the left mirror 120d or the right mirror 120e (e.g., when the left mirror 120d and/or the right mirror 120e are traditional mirrors); and/or (ii) the left rearward field of view 204 and/or the right rearward field of view 206 if displayed by the left mirror 120d or the right mirror 120e due to a smaller size and/or greater distance from the user of the left mirror 120d and/or the right mirror 120e.

When the turn signal of the vehicle 102 is not activated in block 1408, the ECU 106 may determine whether the current vehicle speed is greater than or equal to the vehicle speed threshold (1416).

When the current vehicle speed is greater than or equal to the vehicle speed threshold in block 1416, the ECU 106 may select the rearview mirror 120c as the gaze display (1418). The ECU 106 may select the rearview mirror 120c as the gaze display when the transmission 136 is not in the reverse gear or mode, the turn signal of the vehicle 102 is not activated, and the current vehicle speed is greater than or equal to the vehicle speed threshold because the user is likely not making a lane change at high speeds and is simply checking for traffic behind the vehicle 102 and/or the trailer 202 or is checking a stability of the trailer 202. Therefore, the user may quickly look to see the first rearview field of view 208, the second rearview field of view 210, and/or a reflection of at least a portion of the first rearview field of view 208 in the rearview mirror 120c without having to look down and/or away from the road.

When the current vehicle speed is not greater than or equal to the vehicle speed threshold in block 1416, the ECU 106 may determine whether the current steering angle is greater than or equal to the steering angle threshold (1420). The steering angle threshold may be a number of degrees left or right from a center position of the steering wheel 506 that corresponds to the vehicle 102 turning (e.g., not a small change in direction such as making a lane change). For example, the steering angle threshold may be 10 degrees, 15 degrees, or 20 degrees left or right (e.g., positive or negative) from the center position or may be any number of degrees corresponding to the user making a turn in the vehicle 102 and not a lane change.

When the current steering angle is greater than or equal to the steering angle threshold in block 1420, the ECU 106 may select the user interface 120a or the gauge cluster 120b as the gaze display (1422). The ECU 106 may select the user interface 120a or the gauge cluster 120b as the gaze display when the transmission 136 is not in the reverse gear or mode, the turn signal of the vehicle 102 is not activated, the current vehicle speed is less than the vehicle speed threshold, and the current steering angle is greater than or equal to the steering angle threshold because the user is likely making a turn at low speeds (e.g., turning into a parking lot or navigating a parking lot or tight area). Therefore, it may be advantageous and/or safer to direct the gaze of the user to the user interface 120a or the gauge cluster 120b because the user interface 120a and/or the gauge cluster 120b may display real-time video of the left rearward field of view 204 and/or the right rearward field of view 206 which may provide a greater field of view, a zoomed in field of view, and/or a more clear field of view of the side of the vehicle 102 and/or the trailer 202 than: (i) reflections provided by the left mirror 120d or the right mirror 120e (e.g., when the left mirror 120d and/or the right mirror 120e are traditional mirrors); and/or (ii) the left rearward field of view 204 and/or the right rearward field of view 206 if displayed by the left mirror 120d or the right mirror 120e due to a smaller size and/or greater distance from the user of the left mirror 120d and/or the right mirror 120e.

When the current steering angle is less than the steering angle threshold in block 1420, the ECU 106 may select the rearview mirror 120c as the gaze display (1424). The ECU 106 may select the rearview mirror 120c as the gaze display when the transmission 136 is not in the reverse gear or mode, the turn signal of the vehicle 102 is not activated, the current vehicle speed is less than the vehicle speed threshold, and the current steering angle is less than the steering angle threshold because the user is likely not making a lane change at high speeds or a turn and is simply checking for traffic behind the vehicle 102 and/or the trailer 202 or is checking a stability of the trailer 202. Therefore, the user may quickly look to see the first rearview field of view 208, the second rearview field of view 210, and/or a reflection of at least a portion of the first rearview field of view 208 in the rearview mirror 120c without having to look down and/or away from the road.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A gaze directing system for directing a gaze of a driver of a vehicle, comprising:
one or more displays located on or within the vehicle; and
an electronic control unit (ECU) coupled to the one or more displays and configured to:
determine or receive a plurality of conditions of the vehicle including a current shift position, a current vehicle speed, a current steering angle, and a current turn signal status,
select a display of the one or more displays or a portion of the one or more displays that the driver should gaze at based on one or more conditions of the plurality of conditions, and
generate a gaze indicator indicating the selected display or the selected portion that the driver should gaze at.

2. The gaze directing system of claim 1, further comprising one or more cameras coupled to the ECU and configured to capture real-time video data of one or more fields of view of a surrounding area of the vehicle;
wherein the ECU is further configured to transmit the real-time video data to the selected display.

3. The gaze directing system of claim 2, wherein the one or more fields of view include a left rearward field of view with respect to the vehicle, a right rearward field of view with respect to the vehicle, a first rearward field of view with respect to the vehicle, and/or a second rearward field of view with respect to the vehicle.

4. The gaze directing system of claim 3, wherein the one or more displays include:
an infotainment display configured to display the left rearward field of view, the right rearward field of view, the first rearward field of view, the second rearward field of view, and/or the gaze indicator; and
a digital rearview mirror configured to display the first rearward field of view, the second rearward field of view, and/or the gaze indicator.

5. The gaze directing system of claim 1, wherein the one or more displays include two or more of:
an infotainment display located within a cabin of the vehicle;
a digital rearview mirror located within the cabin;
a digital left side view mirror located within the cabin or on a left side of the vehicle;
a digital right side view mirror located within the cabin or on a right side of the vehicle; or
a digital gauge cluster located within the cabin.

6. The gaze directing system of claim 5, wherein to select the display of the one or more displays or the portion of the one or more displays that the driver should gaze at, the ECU is configured to at least one of:
select the infotainment display or the gauge cluster when the current shift position indicates the vehicle is in reverse;
select the infotainment display or the gauge cluster when:
the current shift position indicates the vehicle is in drive or neutral,
the vehicle speed is less than a vehicle speed threshold, and
the current steering angle is greater than or equal to a steering angle threshold;
select the infotainment display or the gauge cluster when:
the current shift position indicates the vehicle is in drive or neutral,
the vehicle speed is less than a vehicle speed threshold, and
the current turn signal status indicates a turn signal of the vehicle is activated;
select the digital rearview mirror when:
the current shift position indicates the vehicle is in drive or neutral,
the vehicle speed is greater than or equal to the vehicle speed threshold, and
the current turn signal status indicates the turn signal of the vehicle is not activated;
select the digital rearview mirror when:
the current shift position indicates the vehicle is in drive or neutral,
the vehicle speed is less than the vehicle speed threshold,
the current steering angle is less than the steering angle threshold, and
the current turn signal status indicates the turn signal of the vehicle is not activated; or
select the digital left side view mirror or the digital right side view mirror when:
the current shift position indicates the vehicle is in drive or neutral,
the vehicle speed is greater than the vehicle speed threshold, and
the current turn signal status indicates the turn signal of the vehicle is activated.

7. The gaze directing system of claim 1, wherein the gaze indicator is a graphical icon including a graphical representation of at least one display of the one or more displays.

8. The gaze directing system of claim 7, wherein the gaze indicator indicates the selected display by flashing and/or highlighting a graphical representation of the selected display and/or by including an arrow pointing toward the graphical representation of the selected display.

9. The gaze directing system of claim 1, further comprising one or more vehicle sensors electrically connected to the ECU and configured to detect or indicate the one or more conditions.

10. A gaze directing system for directing a gaze of a driver of a vehicle towing a trailer, comprising:
one or more cameras configured to capture real-time video data of one or more fields of view of a surrounding area of the vehicle and the trailer;
one or more displays located on or within the vehicle; and
an electronic control unit (ECU) coupled to the one or more cameras and the one or more displays and configured to:
determine or receive a plurality of conditions of the vehicle including a current shift position, a current vehicle speed, a current steering angle, and a current turn signal status,
select a display of the one or more displays or a portion of the one or more displays that the driver should gaze at based on one or more conditions of the plurality of conditions,
generate a gaze indicator indicating the selected display or the selected portion that the driver should gaze at, and
transmit the real-time video data to the selected display or the selected portion to display at least one field of view of the one or more fields of view on the selected display or the selected portion.

11. The gaze directing system of claim 10, wherein the one or more fields of view include a left rearward field of view with respect to the vehicle, a right rearward field of view with respect to the vehicle, and a rearward field of view with respect to the trailer.

12. The gaze directing system of claim 11, wherein the one or more displays include:
an infotainment display configured to display the left rearward field of view, the right rearward field of view, the rearward field of view, and/or the gaze indicator; and
a digital rearview mirror configured to display the rearward field of view and/or the gaze indicator.

13. The gaze directing system of claim 10, wherein the one or more displays include two or more of:
an infotainment display located within a cabin of the vehicle;
a digital rearview mirror located within the cabin;
a digital left side view mirror located within the cabin or on a left side of the vehicle;
a digital right side view mirror located within the cabin or on a right side of the vehicle; or
a digital gauge cluster located within the cabin.

14. The gaze directing system of claim 13, wherein to select the display of the one or more displays or the portion of the one or more displays that the driver should gaze at, the ECU is configured to at least one of:
select the infotainment display or the gauge cluster when the current shift position indicates the vehicle is in reverse;
select the infotainment display or the gauge cluster when:
the current shift position indicates the vehicle is in drive or neutral,
the vehicle speed is less than a vehicle speed threshold, and
the current steering angle is greater than or equal to a steering angle threshold;
select the infotainment display or the gauge cluster when:
the current shift position indicates the vehicle is in drive or neutral,
the vehicle speed is less than a vehicle speed threshold, and
the current turn signal status indicates a turn signal of the vehicle is activated;
select the digital rearview mirror when:
the current shift position indicates the vehicle is in drive or neutral,
the vehicle speed is greater than or equal to the vehicle speed threshold, and
the current turn signal status indicates the turn signal of the vehicle is not activated;
select the digital rearview mirror when:
the current shift position indicates the vehicle is in drive or neutral,
the vehicle speed is less than the vehicle speed threshold,
the current steering angle is less than the steering angle threshold, and
the current turn signal status indicates the turn signal of the vehicle is not activated; or
select the digital left side view mirror or the digital right side view mirror when:
the current shift position indicates the vehicle is in drive or neutral,
the vehicle speed is greater than the vehicle speed threshold, and
the current turn signal status indicates the turn signal of the vehicle is activated.

15. The gaze directing system of claim 10, wherein the gaze indicator is a graphical icon including a graphical representation of at least one display of the one or more displays.

16. The gaze directing system of claim 15, wherein the gaze indicator indicates the selected display by flashing and/or highlighting a graphical representation of the selected display and/or by including an arrow pointing toward the graphical representation of the selected display.

17. A method for directing a gaze of a driver of a vehicle, comprising:
determining or receiving, via an electronic control unit (ECU) of the vehicle, a plurality of conditions of the vehicle from one or more sensors, the plurality of conditions including a current shift position, a current vehicle speed, a current steering angle, and a current turn signal status;
selecting, via the ECU, a display of one or more displays located on or within the vehicle that the driver should gaze at based on one or more conditions of the plurality of conditions; and
generating, via the ECU, a gaze indicator icon indicating the selected display.

18. The method of claim 17, wherein the one or more displays include two or more of:
an infotainment display located within a cabin of the vehicle;
a digital rearview mirror located within the cabin;
a digital left side view mirror located within the cabin or on a left side of the vehicle;
a digital right side view mirror located within the cabin or on a right side of the vehicle; or
a digital gauge cluster located within the cabin.

19. The method of claim 18, wherein the selecting the display of the one or more displays located on or within the vehicle that the driver should gaze at based on the one or more conditions of the plurality of conditions, includes at least one of:
selecting the infotainment display or the gauge cluster when the current shift position indicates the vehicle is in reverse;
selecting the infotainment display or the gauge cluster when:
the current shift position indicates the vehicle is in drive or neutral,
the vehicle speed is less than a vehicle speed threshold, and
the current steering angle is greater than or equal to a steering angle threshold;
selecting the infotainment display or the gauge cluster when:
the current shift position indicates the vehicle is in drive or neutral,
the vehicle speed is less than a vehicle speed threshold, and
the current turn signal status indicates a turn signal of the vehicle is activated;
selecting the digital rearview mirror when:
the current shift position indicates the vehicle is in drive or neutral,
the vehicle speed is greater than or equal to the vehicle speed threshold, and
the current turn signal status indicates the turn signal of the vehicle is not activated;
selecting the digital rearview mirror when:
the current shift position indicates the vehicle is in drive or neutral,
the vehicle speed is less than the vehicle speed threshold,
the current steering angle is less than the steering angle threshold, and
the current turn signal status indicates the turn signal of the vehicle is not activated; or
selecting the digital left side view mirror or the digital right side view mirror when:
the current shift position indicates the vehicle is in drive or neutral,
the vehicle speed is greater than the vehicle speed threshold, and
the current turn signal status indicates the turn signal of the vehicle is activated.

20. The method of claim 17, wherein the gaze indicator icon indicates the selected display by flashing and/or highlighting a graphical representation of the selected display and/or by including an arrow pointing toward the graphical representation of the selected display.
